(19) United States
(12) Patent Application Publication
(10) Pub. No.: US 2008/0222292 A1
(43) Pub. Date: Sep. 11, 2008

(54) Method for Allowing Multiple Authorized Applicants to Share the Same Port

(75) Inventors: Lilian S. Fernandes, Basavangudi (IN); Vinit Jain, Austin, TX (US); Vasu Vallabhaneni, Austin, TX (US)

Correspondence Address: IBM CORP (YA);C/O YEE & ASSOCIATES PC, P.O. BOX 802333, DALLAS, TX, 75380, US

(73) Assignee: INTERNATIONAL BUSINESS MACHINES CORPORATION, Armonk, NY (US)

(21) Appl. No.: 12/126,683

(22) Filed: May 23, 2008

Related U.S. Application Data
(63) Continuation of application No. 11/301,111, filed on Dec. 12, 2005.

(51) Int. Cl. G06F 15/173

(52) U.S. Cl. 709/226

(57) ABSTRACT

In a method comprising an embodiment of the invention, an original application initially binds to a port, and selects or designates a confidential key, which usefully may be a conventional cookie. The invention also sets a socket option, referred to by way of example, as SO_SECURE_REUSEPORT. The confidential key, together with the port number, is then registered with the operating system of a host associated with the port. In order for another application to subsequently bind to the port, such application must provide the operating system with a key that is identical to the confidential key. In one useful embodiment of the invention, a first application binds a socket to a particular port associated with the host. A specified key is registered with the operating system, and a second application is allowed to bind to the particular port only if the second application can furnish the operating system with a key that matches the specified key.

### BACKGROUND OF THE INVENTION

1. Field of the Invention

The invention claimed herein generally pertains to a method for a network having one or more hosts, wherein it is desired to bind applications to selected ports of the hosts. More particularly, the invention pertains to a method of the above type wherein a socket option may be set that allows multiple applications to bind to the same port. Even more particularly, the invention pertains to a method of the above type wherein a confidential key or the like is used to limit access to the port to certain pre-specified applications.

2. Description of the Related Art

In order to enable multiple applications within a single network host to use Transmission Control Protocol (TCP) communication facilities simultaneously, the TCP provides a set of ports within each host. A port may be thought of as a logical connection place. Each port is uniquely identified by a port number, and the number of a particular port may be used to specify an application program associated with the particular port. As a further concept, a socket is a type of file descriptor that may be used with a port, as an application interface, in order to establish connection between the application and a host. An application may bind a socket to a particular port, by registering the socket and the particular port number with the host operating system.

When an application binds a socket to a port in the above arrangement, no other application is generally allowed to thereafter bind to that port, unless the original application sets a socket option known as SO_REUSEPORT. However, once the original application has set this socket option, it can no longer prevent other applications from sharing the port, whenever desired. Thus, when the SO_REUSEPORT socket option is set for a port, any application that wants to may also bind to that same port.

It will be readily apparent that either use or non-use of the above socket option can create problems, in regard to making connections between multiple applications and a single port. For example, Dynamic Host Configuration Protocol (DHCP) is an Internet protocol for automating the configurations of computers that use TCP/IP. When DHCP sets the conventional SO_REUSEPORT socket option, it only wants two applications, the binld (boot server) and pxed (proxy DHCP) applications, to be able to share the port. However, other applications are not prevented from also accessing the port. The DHCP application has no way of informing the operating system sockets mechanism that port access should be restricted to the binld and pxed applications.

Clearly, it would be beneficial to provide a technique whereby two or more specified applications could share a particular port, while at the same time all non-specified applications were denied access to the port.

### SUMMARY OF THE INVENTION

In accordance with the invention, when an original application initially binds to a port, the application designates a confidential key, usefully comprising a cookie. The application also sets a socket option, referred to by way of example as SO_SECURE_REUSEPORT. The confidential key, together with the port number, is registered with the operating system of a host associated with the port. In order for another application to subsequently bind to the port, such application must provide the operating system with a key that is identical to the confidential key. In one useful embodiment of the invention, directed to a method for a network that includes a host having an operating system, a first application binds a socket to a particular port associated with the host. A specified key is registered with the operating system, and a second application is allowed to bind to the particular port only if the second application can furnish the operating system with a key that matches the specified key.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram showing a network that includes a host client and a host server adapted to implement an embodiment of the invention.

FIG. 2 is a block diagram showing a data processing system that could be used to configure both the host client and the host server of FIG. 1.

FIG. 3 is a chart illustrating features and characteristics of an embodiment of the invention.

FIG. 4 is a flow chart depicting respective steps in carrying out the embodiment of FIG. 3.

### DETAILED DESCRIPTION OF THE PREFERRED EMBODIMENT

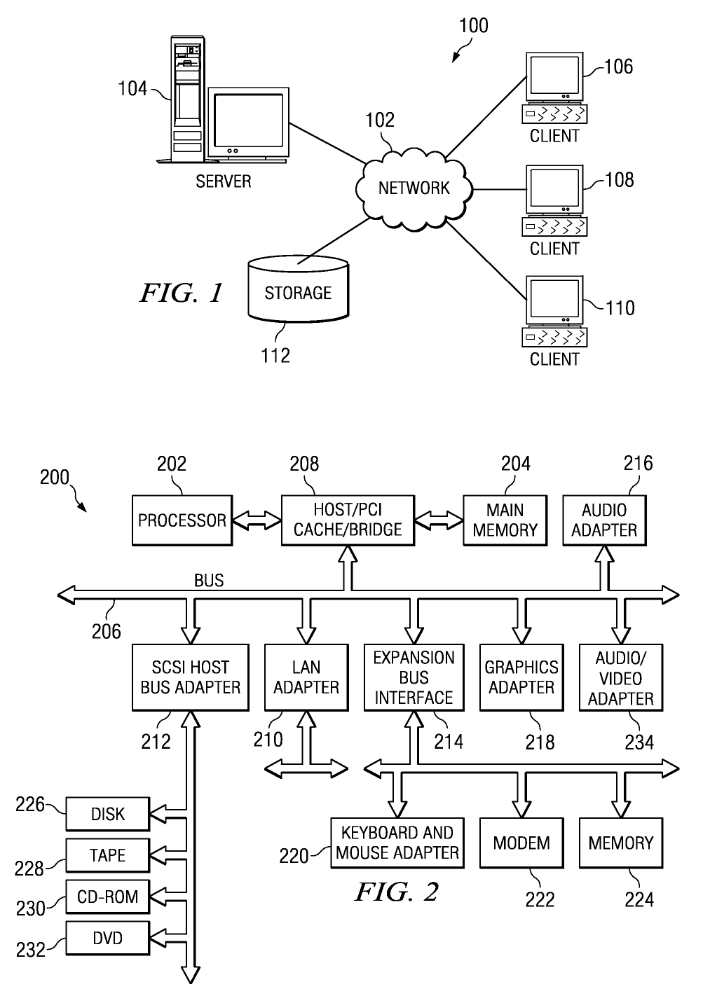

Referring to FIG. 1, there is shown a number of data processing systems 104-110 and a data storage unit 112, respectively connected to a network 102. Network 102 is a medium used to provide communication links between various devices and computers that are respectively included in data processing systems 104-110. Network 102 may include connections using wire, wireless communication links, or fiber optic cables.

In an embodiment of the invention, data processing system 104 usefully comprises a host server connected to network 102, along with storage unit 112. Similarly, systems 106, 108, and 110 usefully comprise host clients, also connected to network 102. These clients 106, 108, and 110 may be, for example, personal computers or network computers. In the depicted example, server 104 provides data, such as boot files, operating system images, and applications to clients 106-110, and such clients are clients to server 104. The network configuration shown in FIG. 1 may, of course, include additional servers, clients, and other devices not shown.

In the example depicted in FIG. 1, network 102 is the Internet, and thus includes a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network 102 may also be implemented as another type of network, such as an intranet, a local area network (LAN), or a wide area network (WAN). FIG. 1 is intended as an example, and not as an architectural limitation for the present invention.

In accordance with an embodiment of the invention, it is assumed that a first application is running on server 104, and has binded a socket to a particular port. A second application, at client 106, is authorized to connect to the first application. Such connection can be made by implementing an embodiment of the invention, as described hereinafter. The embodiment may include the second application sending a message to the server, requesting permission to bind to the particular port. The message would include the identifying number of the particular port and a key that matches specified key.

Referring to FIG. 2, there is shown a block diagram of a data processing system 200 in which aspects of the present invention may be implemented. More particularly, data processing system 200 is an example of a computer which may be adapted for use either as server 104 or client 106 in FIG. 1, and in which computer usable code or instructions implementing processes for embodiments of the present invention may be located. System 200 employs a peripheral component interconnect (PCI) local bus architecture, although other bus architectures, such as Micro Channel and ISA, may alternatively be used.

Processor 202 and main memory 204 are connected to PCI local bus 206 through PCI bridge 208. PCI bridge 208 may also include an integrated memory controller and cache memory for processor 202. Additional connections to PCI local bus 206 may be made through direct component interconnection or through add-in boards. In the depicted example, local area network (LAN) adapter 210, SCSI host bus adapter 212, and expansion bus interface 214 are connected to PCI local bus 206 by direct component connection. Audio adapter 216, graphics adapter 218, and audio/video adapter (A/V) 234 are connected to PCI local bus 206 by add-in boards inserted into expansion slots. Expansion bus interface 214 provides a connection for a keyboard and mouse adapter 220, modem 222, and additional memory 224.

In the depicted example, SCSI host bus adapter 212 provides a connection for hard disk drive 226, tape drive 228, CD-ROM drive 230, and digital video disc read only memory drive (DVD-ROM) 232. Typical PCI local bus implementations will support three or four PCI expansion slots or add-in connectors.

An operating system runs on processor 202 and is used to coordinate and provide control of various components within system 200 of FIG. 2. The operating system may be a commercially available operating system, such as OS/2, which is available from International Business Machines Corporation. _OS/2_ is a trademark of International Business Machines Corporation.

An object oriented programming system, such as Java, may run in conjunction with the operating system, providing calls to the operating system from Java programs or applications executing on system 200. Instructions for the operating system, the object-oriented operating system, and applications or programs are located on a storage device, such as hard disk drive 226, and may be loaded into main memory 204 for execution by processor 202.

Those of ordinary skill in the art will appreciate that the hardware in FIG. 2 may vary depending on the implementation. The depicted example is not meant to imply architectural limitations with respect to the present invention. For example, the processes of the present invention may be applied to multiprocessor data processing systems.

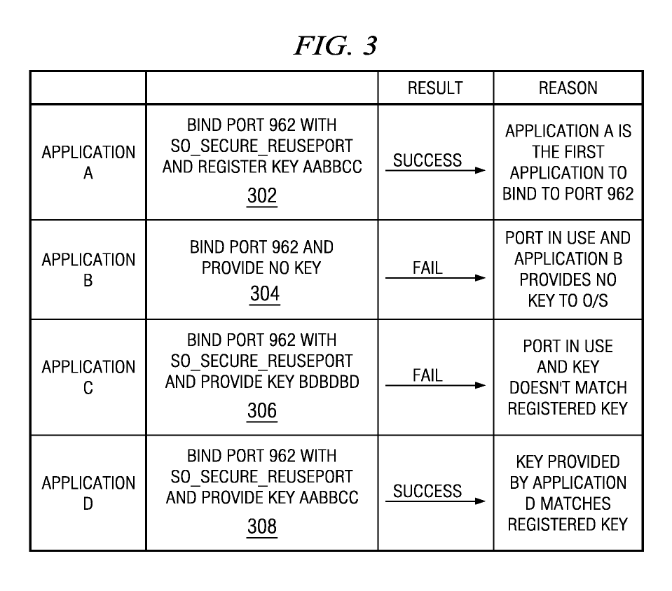

Referring to FIG. 3, there is shown a chart illustrating results that respectively occur, when efforts are made to bind Applications A-D to a port in accordance with an embodiment of the invention. The port is usefully associated with server 104 of FIG. 1, and is arbitrarily selected to have the port number 962.

Event 302 of FIG. 3 indicates that Application A is the first application that attempts to bind port 962. Accordingly, Application A successfully binds port 962, by means of a socket. Application A then sets the socket option identified herein as SO_SECURE_REUSEPORT, although such option could alternatively be given a different name. Application A also registers a unique key AABBCC with the operating system of server 104. This key usefully comprises a conventional cookie, and is to be maintained in confidence or otherwise made known to only a limited number of users.

By setting the socket option SO_SECURE_REUSEPORT, other applications besides Application A can bind port 962, provided that such applications are authorized to do so. In order to demonstrate that it is authorized, an application must furnish a key that is identical to the registered key to the operating system of server 104. By requiring applications after the first or original application to provide the correct key, access of different applications to port 962 can be controlled or restricted as desired.

At event 304, Application B attempts to bind to port 962. However, the port 962 is already in use by Application A. Moreover, Application B does not provide a key to the host operating system. Accordingly, the attempt of Application B to bind to port 962 is seen to fail.

Application C, at event 306, attempts to bind to port 962 and provides a key BDBDBD. However, this key does not match the key required by Application A, and the attempt of Application C is also seen to fail.

Referring further to FIG. 3, event 308 shows Application D attempting to bind to port 962. Application D also furnishes the key AABBCC to the operating system. Since this key matches the registered key, Application D is authorized to bind to port 962. Its effort to do so is therefore successful.

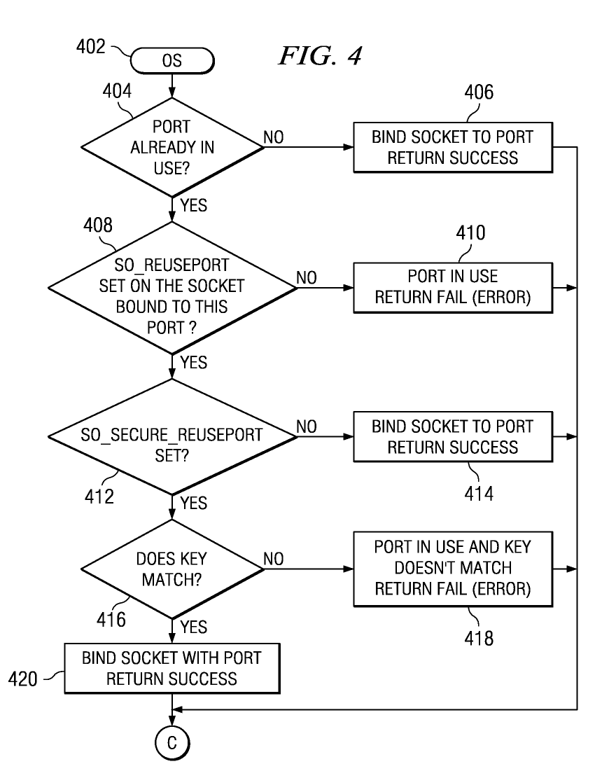

Referring to FIG. 4, there are shown respective steps of a procedure carried out by operating system 402 of server 104, when a given application seeks to bind to a port such as port 962. This procedure may be implemented to achieve the results described above in connection with FIG. 3. As shown by decision block 404, the first step in the procedure is to determine whether or not the port is already being used by a previous application. If not, the port is available, and the given application binds the associated socket to the port, as shown by function block 406. The procedure then concludes, with success for the given application being returned.

If the port is being used by a previous application, so that decision block 404 produces a response of “YES”, it becomes necessary to determine whether the previous application has set the socket option SO_REUSEPORT. As stated above, SO_REUSEPORT is a conventional option that allows any application to share a port with one or more other applications. However, if this option has not been set, no application is allowed to bind the port, if a prior application has already bound the socket thereto. This is shown by function block 410, which indicates failure of the given application to share the port.

Referring further to FIG. 4, decision block 412 shows that if the SO_REUSEPORT socket option was set, it is necessary to further determine whether the SO_SECURE_REUSEPORT socket option was also set. As described above, this option allows any authorized application, but only authorized applications, to share a port with the original application. Thus, if the SO_REUSEPORT option has been set, but the SO_SECURE_REUSEPORT option has not been set, the given application can bind the port, as indicated by function block 414.

If the SO_SECURE_REUSEPORT option is set, a final inquiry must be made, as shown by decision block 416. That is, if decision block 412 produces a “YES” response, it is necessary to determine whether the given application can provide a key to the operating system that matches the registered key. If there are matching keys, the given application is allowed to bind to the port, as shown by function block 420. Otherwise, the effort to bind the port fails for the given application, as shown by function block 418.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. In a network including a host having an operating system, a method comprising the steps of:
binding a first application by means of a socket to a particular port associated with said host;
registering a specified key with said operating system; and
allowing a second application to bind to said particular port only if said second application provides said operating system with a key that matches said specified key.

2. The method of claim 1, wherein:
said first application sets a socket option that requires use of said specified key.

3. The method of claim 2, wherein:
said first application, upon binding to said particular port, registers said specified key, together with a number identifying said particular port, with said operating system.

4. The method of claim 3, wherein:
said operating system is directed to compare said specified key with a key furnished by said second application, in order to determine whether said specified and said furnished keys match each other.

5. The method of claim 4, wherein:
said second application sends a message to said host requesting permission to bind to said particular port, said message including said identifying number of said particular port and a key that matches said specified key.

6. The method of claim 5, wherein:
said host comprises a server connected to a network client that is associated with said second application.

7. The method of claim 4, wherein:
said specified key comprises a cookie, and said socket option is identified as SO_SECURE_REUSEPORT.

8. The method of claim 4, wherein:
said first application comprises DHCP, and said second application is selected from a group that is limited to applications respectively identified as binld and pxed.

9. In a network including a host having an operating system, a computer program product in a computer readable medium comprising:
first instructions for binding a first application by means of a socket to a particular port associated with said host;
second instructions for registering a specified key with said operating system; and
third instructions for allowing a second application to bind to said particular port only if said second application provides said operating system with a key that matches said specified key.

10. The computer program product of claim 9, wherein:
said first application sets a socket option that requires use of said specified key.

11. The computer program product of claim 10, wherein:
said first application, upon binding to said particular port, registers said specified key, together with a number identifying said particular port, with said operating system.

12. The computer program product of claim 11, wherein:
said operating system is directed to compare said specified key with a key furnished by said second application, in order to determine whether said specified and said furnished keys match each other.

13. The computer program product of claim 12, wherein:
said second application sends a message to said host requesting permission to bind to said particular port, said message including said identifying number of said particular port and a key that matches said specified key.

14. The computer program product of claim 13, wherein:
said host comprises a server connected to a network client that is associated with said second application.

15. The computer program product of claim 12, wherein:
said specified key comprises a cookie, and said socket option is identified as SO_SECURE_REUSEPORT.

16. The computer program product of claim 12, wherein:
said first application comprises DHCP, and said second application is selected from a group that is limited to applications respectively identified as binld and pxed.

17. In a host that is included in a network and has an operating system, apparatus comprising:
a first component for binding a first application by means of a socket to a particular port associated with said host;
a second component for registering a specified key with said operating system; and
a third component for allowing a second application to bind to said particular port only if said second application provides said operating system with a key that matches said specified key.

18. The apparatus of claim 17, wherein:
said first application sets a socket option that requires use of said specified key.

19. The apparatus of claim 18, wherein:
said first application, upon binding to said particular port, registers said specified key, together with a number identifying said particular port, with said operating system; and
said operating system is directed to compare said specified key with a key furnished by said second application, in order to determine whether said specified and said furnished keys match each other.

20. The apparatus of claim 19, wherein:
said host comprises a server connected to a network client that is associated with said second application.
